(19) United States
(12) Patent Application Publication
(10) Pub. No.: US 2026/0344816 A1
(43) Pub. Date: Nov. 5, 2026

(54) WEARABLE DISPLAY DEVICE

(71) Applicant: Apple Inc., Cupertino, CA (US)

(72) Inventors: Trevor S. Chambers, San Diego, CA (US); Nicholas R. Trincia, San Francisco, CA (US); Joel Ebers, Seattle, WA (US); Thomas R. Matzinger, Half Moon Bay, CA (US); Patrick J. Crowley, Seattle, WA (US); Kristina A. Babiarz, San Marcos, CA (US); Matin Seadat Beheshti, Sunnyvale, CA (US); Barry D. Curtin, Seattle, WA (US)

(21) Appl. No.: 19/648,614

(22) Filed: Apr. 15, 2026

Related U.S. Application Data
(60) Provisional application No. 63/799,244, filed on May 2, 2025.

(51) Int. Cl. A42B 1/242; G02B 27/01

(52) U.S. Cl. CPC A42B 1/242; G02B 27/0176

(57) ABSTRACT

A wearable display device can include a display frame, an optical module coupled to the display frame, a securement arm coupled to the display frame, and an adjustable forehead pad system. The adjustable forehead pad system can include a forehead pad frame coupled to the display frame, an extension member coupled to the forehead pad frame, and a forehead pad support coupled to the extension member, and the adjustable forehead pad system can be configured to modify a distance between the forehead pad support and the forehead pad frame.

### CROSS-REFERENCE TO RELATED APPLICATIONS

This application claims the benefit of U.S. Provisional Application No. 63/799,244; filed 2 May 2025, entitled “WEARABLE DISPLAY DEVICE,” the entire disclosure of which is hereby incorporated by reference.

### FIELD

The present disclosure relates generally to wearable display devices. More particularly, the present disclosure relates to an adjustment forehead pad for wearable display devices.

### BACKGROUND

Various components of wearable display devices, such as head-mountable displays (HMD), can include display screens, viewing frames, securement arms, speakers, batteries, waveguides, and other components, which operate together to provide an immersive experience. However, fitment can be difficult because user’s heads vary in size and shape, and more specifically, the depth of a user’s eyes can vary from user to user. Display screens or display lenses provide the most optimal immersive experience when the lenses are positioned directly in front of the user’s eyes at a comfortable distance. However, many HMD’s can be difficult to adjust and properly position at a comfortable depth. Therefore, there is a need for an HMD with an effective and simple-to-use adjustment system to selectively modify the distance between the lenses and the user’s eyes.

### SUMMARY

At least one example of the present disclosure includes a wearable display device including a display frame, an optical module coupled to the display frame, a securement arm coupled to the display frame, and an adjustable forehead pad system. The adjustable forehead pad system includes a forehead pad frame coupled to the display frame, an extension member coupled to the forehead pad frame, and a forehead pad support coupled to the extension member. In some examples, the adjustable forehead pad system is configured to modify a distance between the forehead pad support and the forehead pad frame.

In one example, the extension member can be configured to modify the distance to a first distance, a second distance, and a third distance. In one example, the adjustable forehead pad system can include at least one of a mechanical adjustment mechanism, an electromechanical adjustment system, or a hydraulic adjustment mechanism. In one example, the extension member can be linearly coupled to the forehead pad frame. In one example, the adjustable forehead pad system can include at least one of a dial system, a thumbscrew system, or a button system. In one example, the adjustable forehead pad system can include a locking mechanism configured to fix the distance between the forehead pad support and the optical module. In one example, the forehead pad frame can be removably coupled to the display frame. In one example, the adjustable forehead pad system can further include a forehead strap. In one example, the adjustable forehead pad system can include a forehead pad removably coupled to the forehead pad support.

In at least one example of the present disclosure, a wearable display device includes a display frame, an optical module integrated into the display frame, and an adjustable forehead pad system. The adjustable forehead pad system can include a forehead pad frame coupled to the display frame, an extension member coupled to the forehead pad frame, a forehead pad support coupled to the extension member, and a securement arm coupled to the forehead pad extension member. The extension member can be configured to modify a distance between the forehead pad support and the display frame.

In one example, the adjustable forehead pad system can include an adjustment mechanism configured to cause linear adjustment of the distance between the forehead pad support and the display frame. In one example, the adjustment mechanism can include a first rack and pinion coupling the forehead pad frame to the extension member, a second rack and pinion coupling the forehead pad frame to the extension member, and a timing mechanism extending between the first rack and pinion and the second rack and pinion. In one example, the adjustment mechanism can include a lead screw coupling the forehead pad frame to the extension member, a shaft, a gearbox coupling the shaft and the lead screw, and a dial coupled to the shaft and can be configured to extend and retract the lead screw. In one example, the adjustment mechanism can include a locking mechanism configured to hold the extension member at the distance. In one example, the forehead pad frame can be removably coupled to the display frame.

In at least one example of the present disclosure, a wearable display device includes a display frame, an optical module coupled to the display frame, and an adjustable forehead pad system. The adjustable forehead pad system can include a forehead pad frame coupled to the display frame, a bistable link extension member, and a forehead pad support, and the adjustable forehead pad system can be configured to move between a retracted position and an extended position.

In one example, the forehead pad frame can include a frame coupler, the forehead pad support can include a forehead pad coupler, and the bistable link extension member can include a link coupling the frame coupler to the forehead pad coupler. In one example, the bistable link can be rotatably coupled to the frame coupler and the forehead pad coupler. In one example, the adjustable forehead pad system can be configured to move from the retracted position to the extended position via user manipulation. In one example, the adjustable forehead pad system can include an adjustment mechanism configured to cause the adjustable forehead pad system to move between the retracted position and the extended position.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a side view of one example of a wearable display device and a forehead pad system;

FIG. 2 illustrates a top view of one example of a wearable display device and a forehead pad system;

FIG. 3 illustrates a top view of one example of a wearable display device and a forehead pad system;

FIG. 4A illustrates a top view of an example of an adjustable forehead pad system;

FIG. 4B illustrates a top view of an example of an adjustable forehead pad system;

FIG. 5A illustrates a top view of an example of an adjustable forehead pad system;

FIG. 5B illustrates a top view of an example of an adjustable forehead pad system;

FIG. 6 illustrates a top view of an example of an adjustment mechanism for an adjustable forehead pad system;

FIG. 7 illustrates a top view of an example of an adjustment mechanism for an adjustable forehead pad system;

FIG. 8A illustrates a top view of an example of a forehead pad system; and

FIG. 8B illustrates a side view of an example of a forehead pad system.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described embodiments as defined by the appended claims.

The present disclosure generally relates to electronic devices. More particularly, the present disclosure relates to wearable display devices. In at least one example, a wearable display device can include a display frame and a securement arm extending from the frame. Examples of head-mountable devices can include optical devices, for example glasses lenses, goggles with lenses, transparent display windows, display screens or virtual/augmented reality devices that can include optical components. In these examples, the head-mountable device can be donned on the head of a user such that optically transparent widows, for example lenses and transparent optical displays, can be positioned in front of a user’s eyes. User’s heads can vary in size and shape, and more specifically the depth between a user’s eyes and forehead, can vary from user to user. Display screens or display lenses provide the optimal immersive experience when the lenses are positioned in front of the user’s eyes at a comfortable distance for focusing the eyes on the lenses or display. Further, some users may be farsighted and may require prescription lenses to see close objects clearly. As such, the adjustment of a head-mountable device to match a user’s depth can be challenging.

The wearable display devices described herein include a forehead support system. The forehead support system can be removably coupled to the display frame to modify the distance between the user’s eyes and the display. The forehead support system can be adjustable. The adjustment features of the forehead support system can include removable forehead pads with different depths, a glasses support, and/or an adjustment mechanism. The forehead pads can be washable. The wearable display devices can include securement arms coupled to the forehead support system to maintain securement arm tension around the head of a user during adjustment of the forehead support system.

The adjustment systems can be configured to adjust with user manipulation. The adjustment systems can include an actuator for the user to engage with for adjustment. For example, the adjustment systems can include buttons, latches, screws, dials, or the like. The adjustment system can provide adjustment between a retracted position and an extended position. The adjustment systems can provide for finite or continuous adjustment between the retracted position and the extended position. For example, the adjustment systems can include fixed positions for finite adjustment, such as three fixed positions. The forehead pad support and adjustment system can enhance user experience and immersion, increase the comfort of users, and reduce eye strain, and can increase the wearable duration of the wearable display device. The forehead pad support can make the wearable display device easily shared between users with different preferred depths by enabling adjustment between users.

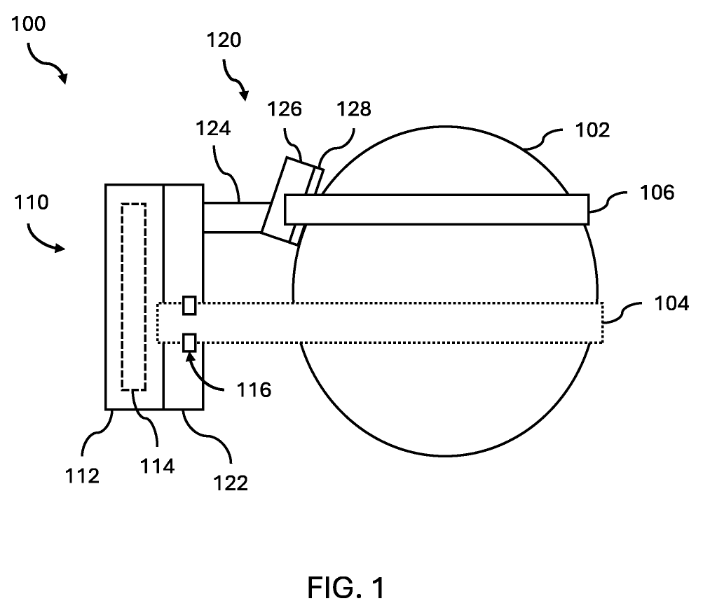

These and other embodiments are discussed below with reference to FIGS. 1 – 8B. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a side view of one example of a wearable display device 100 and a forehead pad system 120. The wearable display device 100 can be a head-mountable device (HMD) or can be any device or system configured to be worn on the head 102 of a user, such as an optical device, smart glasses, alternate/virtual reality goggles, and the like. The device 100 can include at least one display frame 110 which can house a variety of components and systems. In at least one example, the display frame 110 can include a frame body 112 configured to secure a display window, display screen, and/or lenses configured to present visual information to the user. In one example of the present disclosure, the wearable display device 100 can include one or more optical modules 114. The optical modules 114 can include transparent windows without corrective vision properties. The optical modules 114 can also, in some examples, include corrective vision features. The optical modules 114 can be configured next to displays to transmit and/or direct light from the displays to the eyes of the user. The optical modules 114 can be one of a number of components of a display assembly including other components noted above, for example display screens, display support structures, and so forth. In one example, the frame body 112 can include a facial interface. For example, the facial interface can be integrated into the frame body 112. In one example, the facial interface can be removably coupled to the frame body 112. The facial interface can be configured as a light seal configured to block or reduce light that reaches the eyes of a user through the peripheral of the frame body 112.

As illustrated in FIG. 1, the wearable display device 100 can optionally include a securement arm 104 or securement arms. In one example, the wearable display device 100 can include two securement arms 104. The securement arm 104 can be coupled to the frame body 112. In one example, the securement arm 104 can extend from the frame body 112. The securement arm 104 can be configured to support the wearable electronic device 100 on the head 102 of a user. In one example, the securement arm 104 can be configured to support the wearable electronic device 100 on the ears of the user. In some examples, the securement arm 104 can be configured to extend around the head 102 of the user to support the wearable electronic device 100.

The forehead pad system 120 can include a forehead pad frame 122, an extension member 124, and a forehead pad support 126. The forehead pad frame 122 can be configured to couple the forehead pad system 120 to the wearable display device 100, such as the display frame 110, or the frame body 112. In one example, the forehead pad frame 122 can be configured to be removably coupled to the wearable display device 100, such as the display frame 110, or the frame body 112. In one example, the forehead pad frame 122 can be configured to snap to the frame body 112. In one example, the forehead pad frame 122 can be defined by the frame body 112. In one example, the forehead pad frame 122 can include a facial interface, a light shield, or the like. In one example, the forehead pad frame 122 can include protrusions or extensions, near the cheeks of a user. In one example, the protrusions can be configured support eyewear, such as glasses, of a user. In one example, the protrusions can be configured to maintain space between a portion of the wearable display device 100 and the face of a user during use.

The extension member 124 can extend from the forehead pad frame 122. The extension member 124 can be defined by the forehead pad frame 122. In one example, the extension member 124 can be integrated into the forehead pad frame 122. In one example, the extension member 124 can extend from the forehead pad frame 122 at an upper portion of the forehead pad frame 122. The extension member 124 can be configured to establish a depth or distance between a display of the wearable display device 100 and the eyes of a user. For example, different forehead pad frames 122 can be configured to include extension members 124 of varying depths.

The forehead pad support 126 can be configured to support the forehead of a user. In one example, the forehead pad support 126 can be integrated into the extension member 124 or the forehead pad frame 122. In one example, the forehead pad support 126 can be defined by the extension member 124 or the forehead pad frame 122. In one example, the forehead pad support 126 can define an angle relative to the extension member 124 to rest on the forehead of a user.

The forehead pad support 126 can include a forehead pad 128. In one example, the forehead pad 128 can be fixed to the forehead pad support 126. In one example, the forehead pad 128 can be configured to couple to the forehead pad support 126. For example, the forehead pad 128 can be removably coupled to the forehead pad support 126 via magnets, snaps, hook and loops, or the like. In one example, the forehead pad 128 can be configured for user comfort. In one example, the forehead pad 128 can be washable. For example, the forehead pad 128 can include a silicone material. In one example, the forehead pad 128 can include a fabric wrap. In one example, the forehead pad 128 can define a depth. The depth can be configured to contribute to the overall depth or distance between the user’s eyes and a display. In one example, different forehead pads 128 can be configured to have different depths.

In one example, the forehead pad frame 122 can include a securement arm attachment mechanism 116. The securement arm attachment mechanism 116 can be defined by the forehead pad frame 122. The securement arm attachment mechanism 116 can be configured to secure or support the securement arm 104 on the forehead pad frame 122. In one example, the securement arm attachment mechanism 116 can include a lower protrusion, such that the attachment arm 104 can rest on the protrusion. In one example, the lower protrusion can be curved or angled. In one example, the securement arm attachment mechanism 116 can include the lower protrusion and an upper protrusion. The upper protrusion can be curved or angled. In one example, one of the lower protrusion or the upper protrusion can be curved or angled. In one example, both of the lower protrusion or the upper protrusion can be curved or angled. In one example, the securement arm attachment mechanism 116 can be configured to clip the securement arm 104 in place. In one example, the securement arm attachment mechanism 116 can be configured to extend around the securement arm 104. For example, the securement arm 104 can be fed through an aperture of the securement arm attachment mechanism 116.

In one example, the forehead pad system 120 can include a forehead strap 106. The forehead strap 106 can be coupled to the forehead pad frame 122. In one example, the forehead strap 106 can extend from the forehead pad frame 122. In one example, the forehead pad strap 106 can extend from or be coupled to the extension member 124 or the forehead support 126. The forehead strap 106 can be configured to support the wearable electronic device 100 on the head 102 of a user. The forehead strap 106 can be configured to extend around the head 102 of the user to support the wearable electronic device 100. In one example, the wearable display device 100 can include a forehead strap 106 and the securement arm 104. In one example, the wearable display device 100 can include the forehead strap 106 without the securement arm 104.

Any of the features, components, and/or parts, of the wearable display device 100 including the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

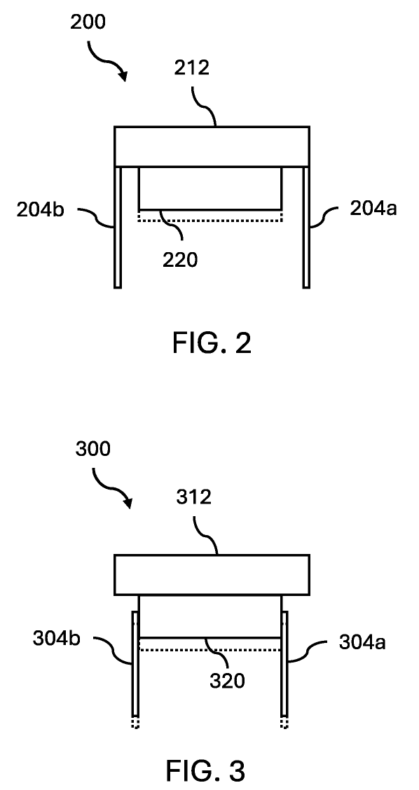

FIG. 2 illustrates a top view of one example of a wearable display device 200 and a forehead pad system 220. The wearable display device 200 can include a frame body 212, securement arms 204a-b, and a forehead pad system 220. The frame body 212 can be substantially similar to the frame body 112. The securement arms 204a-b can be substantially similar to the securement arm 104. As illustrated in FIG. 2, the securement arms 204 can be coupled to the frame body 212.

The forehead pad system 220 can be configured to be adjustable. As shown in FIG. 2, the forehead pad system 220 can be configured to move from a first position to a second position. In one example, the first position defines a first distance from the frame body 212 and the second position defines a second distance from the frame body 212. In one example, the forehead pad system 220 can be configured to adjust with respect to the frame body 212 and the securement arms 204a-b.

In one example, the forehead pad system 220 can include a slider lock. When the slider lock is in the unlocked position, the forehead pad system 220 can be configured to move by a spring-loaded extension. In one example, when the slider lock is in the unlocked position, the forehead pad system 220 can be configured to move by a force applied by a user. In one example, the slider lock can lock the forehead pad system is a retracted position and/or an extended position. In one example, the forehead pad system 220 can include a dial. The dial can be configured to cause extension and retraction of the forehead pad system 220. In one example, the forehead pad system 220 can include rotary dampers such that the position of the forehead pad system 220 is held by friction and the rotary dampers.

Any of the features, components, and/or parts, of the wearable display device 200 including the arrangements and configurations thereof shown in FIG. 2 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 2.

FIG. 3 illustrates a top view of one example of a wearable display device 300 and a forehead pad system 320. The wearable display device 300 can include a frame body 312, securement arms 304a-b, and a forehead pad system 320. The frame body 312 can be substantially similar to the frame body 112. The securement arms 304a-b can be substantially similar to the securement arm 104. As illustrated in FIG. 3, the securement arms 304 can be coupled to the forehead pad system 320.

The forehead pad system 320 can be configured to be adjustable. As shown in FIG. 3, the forehead pad system 320 can be configured to move from a first position to a second position. In one example, the first position defines a first distance from the frame body 312 and the second position defines a second distance from the frame body 312. In one example, the securement arms 304a-b are configured to move with the forehead pad system 320. By adjusting the forehead pad system 320, with the securement arms 304a-b coupled to the forehead pad system 320, the securement arms 304a-b can be configured to move with the forehead pad system 320. In one example, the securement arms 304a-b can maintain tension during adjustment of the forehead pad system 320. In one example, the frame body 312 can be configured to move with respect to the forehead pad system 320 and the securement arms 304a-b.

In one example, the forehead pad system 320 can include a slider lock. When the slider lock is in the unlocked position, the forehead pad system 320 can be configured to move by a spring-loaded extension. In one example, when the slider lock is in the unlocked position, the forehead pad system 320 can be configured to move by a force applied by a user. In one example, the slider lock can lock the forehead pad system in a retracted position and/or an extended position. In one example, the forehead pad system 320 can include a dial. The dial can be configured to cause extension and retraction of the forehead pad system 320. In one example, the forehead pad system 320 can include rotary dampers such that the position of the forehead pad system 320 is held by friction and the rotary dampers.

Any of the features, components, and/or parts, of the wearable display device 300 including the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

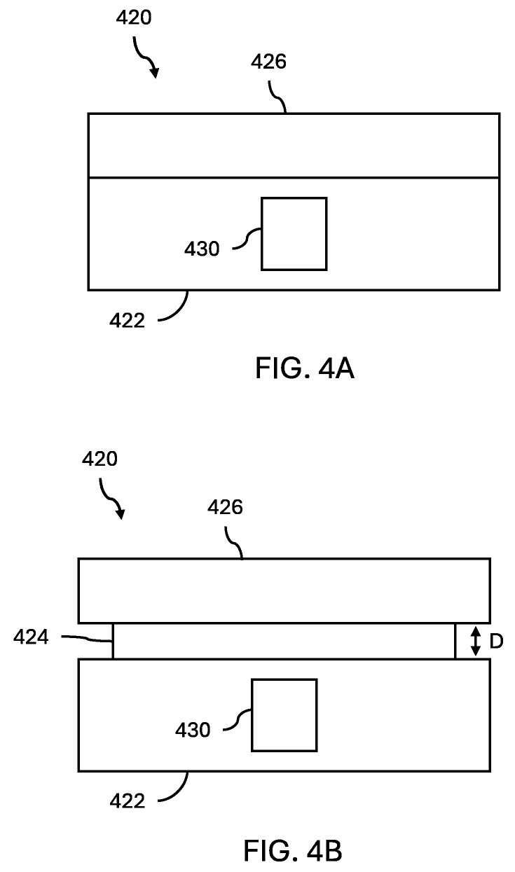

FIGS. 4A – 4B illustrate an example of an adjustable forehead pad system 420. The adjustable forehead pad system 420 can include a forehead pad frame 422, an extension member 424, and a forehead pad support 426.

The forehead pad frame 422 can be configured to couple the forehead pad system 420 to a wearable display device, such as a display frame, or frame body. In one example, the forehead pad frame 422 can be configured to be removably coupled to a wearable display device, such as a display frame, or frame body.

The forehead pad support 426 can be configured to support the forehead of a user. In one example, the forehead pad support 426 can define an angle relative to the forehead pad frame 422 in order to provide a desired orientation for the forehead pad to rest on the forehead of a user. The forehead pad support 426 can include a forehead pad. In one example, the forehead pad can be fixed or removably coupled to the forehead pad support 426. In one example, the forehead pad support 426 can provide a datum that at least partially defines a depth or distance between the user’s eyes and a display.

The forehead pad system 420 can be configured to be adjustable. In one example, the forehead pad system 420 can be adjustable by a distance, as indicated by arrow D. In one example, the distance can be about 5 mm to about 30 mm, about 5 mm to about 20 mm, about 5 mm to about 15 mm, or about 10 mm. The forehead pad system 420 can be configured to move the extension member 424 the distance, as indicated by arrow D. In one example, the extension member 424 can be configured to cause adjustment at multiple distances. In one example, each of the multiple distances is a fixed distance. In one example, the extension member 424 can be linearly coupled to the forehead pad frame 422. In one example, the forehead pad system 420 can be manually adjusted by applying a linear force.

In one example, the adjustable forehead pad system 420 can include an adjustment mechanism 430. The adjustment mechanism 430 can be configured to cause extension and retraction of the extension member 424. In one example, the adjustment mechanism 430 can cause adjustment by the distance, as indicated by arrow D. In one example, the adjustment mechanism 430 can be configured to cause continuous, incremental adjustment of the adjustable forehead pad system 420. In one example, the adjustment mechanism 430 can be configured to cause fixed adjustment of the adjustable forehead pad system 420.

In one example, the adjustment mechanism 430 can be a dial system. The dial system can include a dial rotatably coupled to a threaded rod. In one example, rotation of the dial can cause pushing or pulling on the extension member 424 to cause extension or retraction of the extension member 424. In one example, the extension member 424 can be linearly coupled to the dial system. For example, the extension member 424 and the forehead pad frame 422 can include lap-joint guides. In one example, the dial system can cause continuous, incremental adjustment of the adjustable forehead pad system 420. In one example, the dial system can include a compression component to fix the position of the extension member 424.

In one example, the adjustment mechanism 430 can be a thumbscrew system. The thumbscrew system can include a rotatable thumb screw. The extension member 424 can include a spring finger. In one example, the extension member 424 can be linearly coupled to the thumbscrew system. For example, the extension member 424 and the forehead pad frame 422 can include lap-joint guides. In one example, the thumbscrew can cause continuous, incremental adjustment of the adjustable forehead pad system 420. In one example, rotation of the thumbscrew can cause release of the spring finger of the extension member 424 such that the extension member 424 can be movable. For example, rotation of the thumbscrew in a first direction can release, or unlock, the spring finger of the extension member 424. When unlocked, the spring finger can be released, and the extension member 424 can moved. In one example, rotation of the thumbscrew in a second direct can secure, or lock, the spring finger of the extension member 424. In one example, the thumbscrew system can cause continuous, incremental adjustment of the adjustable forehead pad system 420. In one example, the thumbscrew system can cause fixed adjustment of the adjustable forehead pad system 420. In one example, the thumbscrew system can include debossers, ejectors, or protruding elements, under the thumb screw in multiple positions. In one example, the thumbscrew system can include a ramped portion, such as part of the ejector.

In one example, the adjustment mechanism 430 can be a button system. The button system can include a button, such as a momentary button. In one example, the button can be configured to only enable movement of the extension member 424 when the button is pushed. In one example, when the button is pushed, the extension member 424 can be moved from a first position to a second position. In one example, the extension member 424 can include a spring finger and the forehead pad frame 422 can include depressions. For example, the forehead pad frame 422 can include a first depression for a retracted position and a second depression for an extended position. In one example, when the button is pushed, the spring finger can flex, enabling the spring finger to move between depressions. Upon release of the button, the button can be configured to lock the position of the extension member 424 relative to the forehead pad frame 422. In one example, the button can be pushed to unlock and pushed again to lock. In one example, the button system can include a clutch pack to apply friction to hold the position of the extension member 424.

Any of the features, components, and/or parts, of the adjustable forehead pad system 420 including the arrangements and configurations thereof shown in FIGS. 4A – 4B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 4A – 4B.

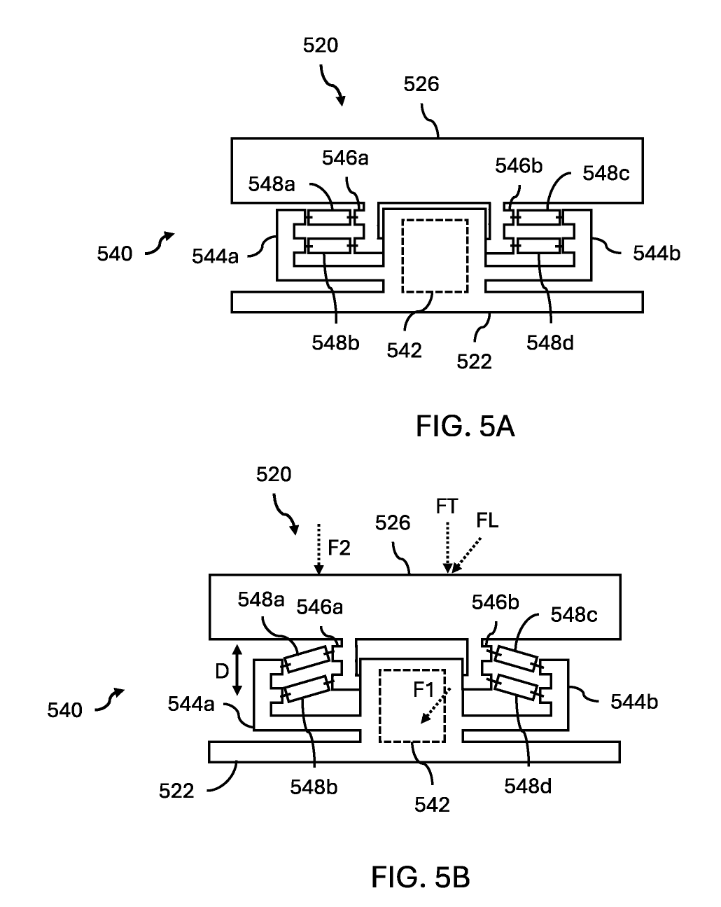

FIGS. 5A – 5B illustrate an example of an adjustable forehead pad system 520. The adjustable forehead pad system 520 can include a forehead pad frame 522, an adjustment system 540, and a forehead pad support 526. The forehead pad frame 522 can be substantially similar to the forehead pad frame 422. The forehead pad support 526 can be substantially similar to the forehead pad support 426.

The adjustment system 540 can be configured to cause extension and retraction of the forehead pad support 526. The adjustment system 540 can be configured to move the forehead pad 526 the distance, as indicated by arrow D. In one example, the distance can be about 5 mm to about 30 mm, about 5 mm to about 20 mm, about 5 mm to about 15 mm, or about 10 mm. In one example, the adjustment system 540 can be a bistable link. The adjustment system 540 can include frame couplers 544a-b, forehead pad couplers 546a-b, and links 548a-b.

In one example, the forehead pad frame 522 can include the frame couplers 544a-b. The frame couplers 544a-b can extend from an intermediate area of the forehead pad frame 522 towards the sides of the forehead pad frame 522. In one example, the frame couplers 544a-b can be the same material as the forehead pad frame 522. In one example, the frame couplers 544a-b can be a flexure. For example, the geometry or material of the frame couplers 544a-b can cause the frame couplers 544a-b to have a flexure spring force. In one example, the frame couplers 544a-b can have flexibility in one or more degrees of freedom. The frame couplers 544a-b can be configured to couple to links 548a-d.

In one example, the forehead pad support 526 can include the forehead pad couplers 546a-b. The forehead pad couplers 546a-b can extend from an intermediate area of the forehead pad support 526 towards the forehead pad frame 522. In one example, the forehead pad couplers 546a-b can be the same material as the forehead pad support 526. In one example, the forehead pad couplers 546a-b can be a flexure. For example, the geometry or material of the forehead pad couplers 546a-b can cause the forehead pad couplers 546a-b to have a flexure spring force. In one example, the forehead pad couplers 546a-b can have flexibility in one or more degrees of freedom. The forehead pad couplers 546a-b can be configured to couple to links 548a-d.

In one example, the forehead pad couplers 546a-b can be movably coupled to the forehead pad frame 522. In one example, the forehead pad couplers 546a-b can be movably coupled to the intermediate area of the forehead pad frame 522. In one example, the forehead pad couplers 546a-b can be slidably coupled to the forehead pad frame 522. In one example, the forehead pad frame 522 can define a first depression and a second depression. In one example, the depressions can define a first position and a second position of the adjustable forehead pad system 520, such as the forehead pad couplers 546a-b. In one example, the forehead pad frame 522 can define a ramp between the first position and the second position. For example, the ramp can cause the forehead pad couplers 546a-b to engage in the first position and the second position. In one example, the forehead pad couplers 546a-b, and therefore the forehead pad support 526, can move from the first position to the second position by moving along the ramp. In one example, pulling on the forehead pad support 526 can cause the forehead pad couplers 546a-b to move from the first position to the second position. For example, the forehead pad couplers 546a-b can move along the ramp and drop into the second position. In one example, the second depression can be at one end of the ramp, locking the forehead pad couplers 546a-b in the second position. In one example, the forehead pad frame 522 can define a tooth between the first position and the second position, such as between the first depression and the second depression. In one example, to move from the second position to the first position, a transverse force, as indicated by arrow FT, can be applied to the forehead pad support 526. For example, the transverse force can release the forehead pad couplers 546a-b from the second depression. In one example, to move from the second position to the first position, a lateral force, as indicated by arrow FL, can be applied to the forehead pad support 526. For example, the lateral force can cause the forehead pad support 526 to move toward the forehead pad frame 522. In one example, to move from the second position to the first position, both the transverse force and the lateral force can be applied to the forehead pad support 526. For example, the transverse force can release the forehead pad couplers 546a-b from the second depression while the lateral force can cause the forehead pad support 526 to move toward the forehead pad frame 522. While two positions are described, the forehead pad frame 522 can be configured with more than two positions. In one example, the forehead pad couplers 546a-b can be coupled to the forehead pad frame 522 to allow continuous adjustment.

The links 548a-d can be coupled to the frame couplers 544a-b and the forehead pad couplers 546a-b. In one example, the links 548a-d can be rotatably coupled to the frame couplers 544a-b and the forehead pad couplers 546a-b. In one example, the links 548a-d can be positioned such that two links 548a-b are positioned on a first side of the forehead pad system 520 and two links 548c-d are positioned on a second side of the forehead pad system 520. In one example, the links 548a-d can establish the distance, as indicated by arrow D, that the adjustment system 520 can be adjustable. For example, the distance can be established by the length of the links 548a-d, the angle of coupling of links 548a-b to the frame couplers 544a-b and the forehead pad couplers 546a-b, or a combination thereof.

In one example, the adjustable forehead pad system 520 can include an adjustment mechanism 542. The adjustment mechanism 542 can be configured to cause extension and retraction of the adjustment system 540. In one example, the adjustment mechanism 542 can cause adjustment by the distance, as indicated by arrow D. In one example, the adjustment mechanism 542 can be configured to cause continuous, incremental adjustment of the adjustment system 540. In one example, the adjustment mechanism 542 can be configured to cause fixed adjustment of the adjustment system 540.

In one example, the adjustment mechanism 542 can be a dial system. The dial system can include a dial rotatably coupled to a threaded rod. In one example, rotation of the dial can cause pushing or pulling on the adjustment system 540 to cause extension or retraction of the adjustment system 540. In one example, the dial system can cause continuous, incremental adjustment of the adjustment system 540. In one example, the dial system can include a compression component to fix the position of the adjustment system 540.

In one example, the adjustment mechanism 542 can be a lever latch. In one example, the lever latch can define two positions of the adjustment system 540, extended and retracted. In one example, the lever latch can define more than two positions. In one example, the lever latch can be configured to cause extension of the adjustment system 540 by a pulling action on the forehead pad support 526. In one example, when in the fully extended position, the lever latch secures the position of the adjustment system 450. In one example, to retract the forehead pad support 526, force can be applied to the lever latch, shown as F1, or the lever latch can be pushed. In one example, to retract the forehead pad support 526, a force can be applied to the forehead pad support 526, shown as F2. In one example, to retract the forehead pad support 526, the level latch can be pushed with a force, shown as F1, and a force can be applied to the forehead pad support 526, shown as F2.

Any of the features, components, and/or parts, of the adjustable forehead pad system 520 including the arrangements and configurations thereof shown in FIGS. 5A – 5B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 5A – 5B.

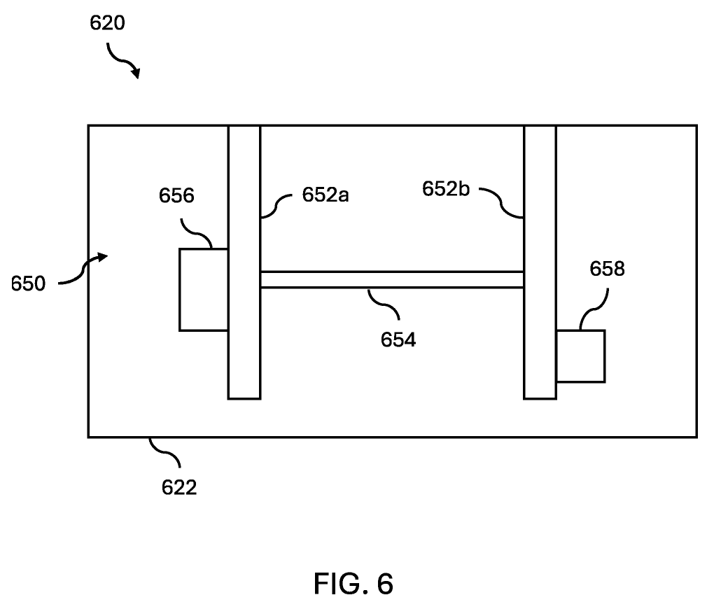

FIG. 6 illustrates an example of an adjustment mechanism 650 for an adjustable forehead pad system 620. In one example, the adjustment mechanism 650 can reside in an internal cavity of a forehead pad frame 622. The adjustment mechanism 650 can be a mechanism system, an electromechanical system, or a hydraulic system. The forehead pad frame 622 can be substantially similar to the forehead pad frame 422 and 522. The adjustment mechanism 650 can include extension sliders 652a-b, a timing shaft 654, and a rotary damper 656.

The extension sliders 652a-b can be configured to cause extension and retraction of the adjustable forehead pad system 620. In one example, the extension sliders 652a-b can be coupled to an extension member, a bistable link mechanism, a forehead pad support, or a combination thereof. In one example, the extension sliders 652a-b can linearly couple the forehead pad frame 622 to an extension member, a bistable link mechanism, a forehead pad support, or a combination thereof. In one example, the extension sliders 652a-b can include rack gears, such as for a rack and pinion system. In one example, the extension sliders 652a-b can include low profile linear bearings. In one example, the extension sliders 652a-b can include a gib adjustment to eliminate play.

The timing shaft 654 can extend between the extension sliders 652a-b. In one example, the timing shaft 654 can be configured to the couple the extension sliders 652a-b together. The timing shaft 654 can be configured to synchronize movement of the extension sliders 652a-b. In one example, the timing shaft 654 can include one or more torsion springs. The torsion springs can be configured to return the adjustable forehead pad system 620 to a retracted position when no additional forces are present.

In one example, the extension slider 652a can be coupled to the rotary damper 656. For example, the extension slider 652a can be movably coupled to the rotary damper 656. The rotary damper 656 can be configured to control movement of the extension slider 652a. In one example, the rotary damper 656 can be configured to control adjustment of the adjustable forehead pad system 620. In one example, both extension sliders 652a-b can include a rotary damper. In one example, the rotary damper 656 can decrease the velocity of adjustment. In one example, the rotary damper 656 can be configured to enable adjustment of the adjustable forehead pad system 620 by pulling and pushing on the forehead pad support. In one example, the adjustment mechanism 650 can include a rotary detent configured to provide similar function as the rotary damper 656. In one example, the rotary detent, or the rotary damper, can provide haptic feedback to a user during adjustment.

In one example, the adjustment mechanism 650 can include a lock mechanism 658. In one example, the lock mechanism 658 can be a button. In one example, the lock mechanism can be a sliding lock with springs. The locking mechanism 658 can be configured to enable and prevent adjustment of the adjustable forehead pad system 620. In one example, the locking mechanism 658 can enable adjustment when actuated, and prevent adjustment when released. In one example, the locking mechanism can enable adjustment when actuated a first time and prevent adjustment when actuated a second time. In one example, the locking mechanism 658 can be spring loaded toward a head of a user donning the HMD. In one example, the lock mechanism 658 can include a ratchet lock defining two or more positions. For example, the lock mechanism 658 can include four or more positions.

Any of the features, components, and/or parts, of the adjustable forehead pad system 620 including the arrangements and configurations thereof shown in FIG. 6 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 6.

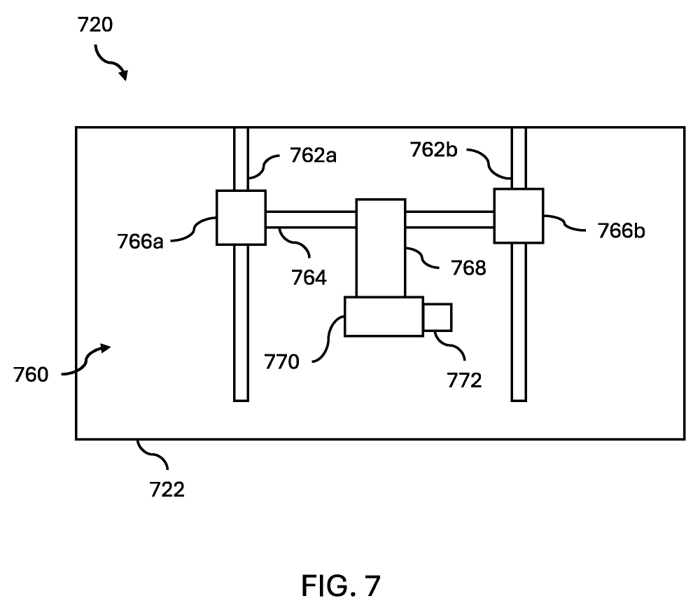

FIG. 7 illustrates an example of an adjustment mechanism 760 for an adjustable forehead pad system 720. In one example, the adjustment mechanism 760 can reside in an internal cavity of a forehead pad frame 722. The forehead pad frame 722 can be substantially similar to the forehead pad frame 422, 522, and 622. The adjustment mechanism 760 can include a dial 770, a gearbox 768, a shaft 764, extension members 762a-b, and gearboxes 766a-b.

The dial 770 can be configured to partially extend through the forehead pad frame 722. For example, a portion of the dial 770 can be accessible on an exterior of the forehead pad frame 722 and a portion of the dial 770 can be positioned in the internal cavity of the forehead pad frame 722. In one example, the dial 770 can be configured to cause linear extension and retraction of the adjustable forehead pad system 720. In one example, the dial 770 can be configured to cause continuous adjustment of the adjustable forehead pad system 720. The dial 770 can be coupled to the shaft 764. For example, the dial 770 can be coupled to the shaft 764 via the gearbox 768.

The gearbox 768 can be configured to couple the dial 770 to the shaft 764. In one example, the gearbox 768 can be configured to convert rotation of the dial 770 into rotation of the shaft 764. For example, the dial 770 can be configured to rotate about a first axis and the shaft 764 can be configured to rotate about a second axis, transverse to the first axis. For example, the gearbox 768 can include one or more 90-degree gears.

The shaft 764 extend between the extension members 762a-b. In one example, the shaft 764 can be configured to the couple the extension members 762a-b together. In one example, a first shaft 764 can be configured to couple to the first extension member 766a and a second shaft 764 can be configured to couple to the second extension member 766b. In one example, the shaft 764 can be configured to synchronize movement of the extension members 762a-b. For example, the shaft 764 can be a timing shaft. The shaft 764 can couple to the extension members 772a-b via gearboxes 766a-b.

The extension members 762a-b can be configured to cause extension and retraction of the adjustable forehead pad system 620. In one example, the extension members 762a-b can be coupled to an external extension member, a bistable link mechanism, a forehead pad support, or a combination thereof. In one example, the extension members 762a-b can linearly couple the forehead pad frame 622 to an extension member, a bistable link mechanism, a forehead pad support, or a combination thereof. The extension members 762a-b can be configured to cause linear movement in response to the rotational movement of the gearboxes 766a-b. In one example, the extension members 762a-b can be lead screws. In one example, the extension members 762a-b can include lead nut to facilitate linear movement.

The gearboxes 766a-b can be configured to couple the shaft 764 to the extension members 762a-b. In one example, the gearboxes 766a-b can be configured to convert rotation of the shaft 764 into rotation and/or linear movement of the extension members 762a-b. For example, the shaft 764 can be configured to rotate about a first axis and the extension members 762a-b can be configured to rotate about a second axis, transverse to the first axis. Rotation in the second direction can be configured to cause extension and retraction of the extension members 762a-b. For example, the gearbox 768 can include one or more 90-degree gears.

In one example, the adjustment mechanism 760 can include a locking mechanism 772. The locking mechanism 772 can be configured to fix rotation of the dial in a given position. In one example, the locking mechanism 772 can be a lock button. In one example, the locking mechanism 772 can be a detent mechanism. In one example, the locking mechanism 772 can be a ball plunger.

Any of the features, components, and/or parts, of the adjustable forehead pad system 720 including the arrangements and configurations thereof shown in FIG. 7 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 7.

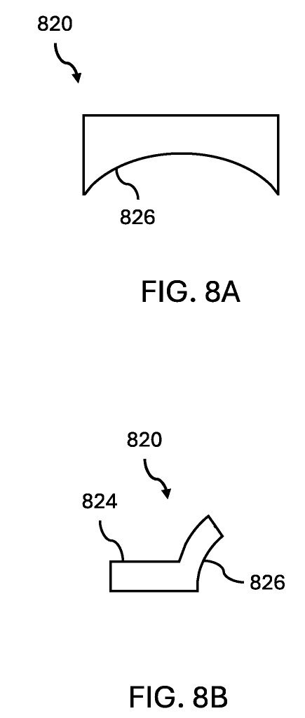

FIGS. 8A – 8B illustrate an example of a forehead pad system 820. The forehead pad system 820 can be substantially similar to the forehead pad systems 120, 220, 320, 420, 520, 620, and 720. The forehead pad system 820 can include an extension member 824 and a forehead pad support 826. The extension member 824 can be substantially similar to extension members 124, 424, 524, 624 and 724.

The forehead pad support 826 can be configured to support the forehead of a user. As illustrated in FIG. 8B, the forehead pad support 826 can define an angle relative to the extension member 824 to rest on the forehead of a user. For example, the angle of the forehead pad support 826 relative to the extension member 824 can define a curvature to conform to the forehead of the user. The curvature of the forehead pad support 826 relative to the extension member 824 can align with a sagittal or median plane of the forehead of a user. As such, the forehead pad support 826 can rest on the forehead of the user and can provide comfort, customizable fit, support and securement of the wearable display device, etc. As illustrated in FIG. 8A, the forehead pad support 826 can define curvature to align with a transverse plane of the forehead of a user. For example, the forehead pad support 826 can extend further from the extension member 824 on the sides compared to a central region. The forehead pad support 826 can conform to the curved surfaces and contour of a forehead of a user for comfort, customization, support and securement of the wearable display device, etc.

Any of the features, components, and/or parts, of the wearable display device 800 including the arrangements and configurations thereof shown in FIGS. 8A – 8B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 8A – 8B.

Referring generally to FIGS. 1 – 8B, the adjustable forehead pad systems can be configured with three positions, or distances. For example, the positions can include a fully retracted position, a fully extended position, and an intermediate position. In one example, the adjustable forehead pad system can be configured for adjustment on the head of a user donning the HMD, off the head of the user donning the HMD, or a combination thereof. In one example, the position of an actuator (e.g., button, lever latch, thumb screw, ratchet mechanism, or the like), can determine whether adjustment can be done on or off the head. In one example, the actuator can be position within the forehead pad system. In one example, the actuator and/or a locking mechanism of the adjustable forehead pad system can be positioned under a cover of the adjustable forehead pad system.

In one example, the adjustable forehead pad system can be configured to interact with an application on a user device (e.g., a mobile phone, the HMD, or the like). In one example, the application can determine the optical position of the adjustable forehead pad system. In one example, the HMD can be configured to detect one or more features of the user donning the HMD. For example, the HMD can detect the eye(s) of a user, cheek or facial features, or other facial landmarks. The HMD can be configured to determine a depth of the facial feature or landmarks. Using the depth of the facial feature or landmark, the HMD can determine an optical distance for the adjustable forehead pad system. In one example, the HMD can be configured to provide a recommended position for the forehead pad support. For example, the HMD can display a recommendation, provide an indication the forehead pad support is in a correct position, or the like. In one example, the HMD can be configured to automatically adjust the adjustable forehead pad system. In one example, the HMD can include an encoder. The encoder can be configured to remember the position of a specified user. For example, the encoder can be configured to cause the adjustable forehead pad system to automatically adjust based on the user donning the HMD.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X® (formerly TWITTER®) ID’s, home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user’s general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to "opt in" or "opt out" of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A wearable display device, comprising:
a display frame;
an optical module coupled to the display frame;
a securement arm coupled to the display frame; and
an adjustable forehead pad system, comprising:
a forehead pad frame coupled to the display frame;
an extension member coupled to the forehead pad frame; and
a forehead pad support coupled to the extension member;
wherein the adjustable forehead pad system is configured to modify a distance between the forehead pad support and the forehead pad frame.

2. The wearable display device of claim 1, wherein the extension member is configured to modify the distance to a first distance, a second distance, and a third distance.

3. The wearable display device of claim 1, wherein the adjustable forehead pad system further comprises a mechanical adjustment mechanism, an electromechanical adjustment mechanism, or a hydraulic adjustment mechanism.

4. The wearable display device of claim 1, wherein the extension member is linearly coupled to the forehead pad frame.

5. The wearable display device of claim 1, wherein the adjustable forehead pad system further comprises a dial system, a thumbscrew system, or a button system.

6. The wearable display device of claim 1, wherein the adjustable forehead pad system further comprises a locking mechanism configured to fix the distance between the forehead pad support and the optical module.

7. The wearable display device of claim 1, wherein the forehead pad frame is removably coupled to the display frame.

8. The wearable display device of claim 1, wherein the adjustable forehead pad system further comprises a forehead strap.

9. The wearable display device of claim 1, wherein the adjustable forehead pad system further comprises a forehead pad removably coupled to the forehead pad support.

10. A wearable display device, comprising:
a display frame;
an optical module integrated into the display frame; and
an adjustable forehead pad system, comprising:
a forehead pad frame coupled to the display frame;
an extension member coupled to the forehead pad frame;
a forehead pad support coupled to the extension member; and
a securement arm coupled to the extension member;
wherein the extension member is configured to modify a distance between the forehead pad support and the display frame.

11. The wearable display device of claim 10, wherein the adjustable forehead pad system further comprises an adjustment mechanism configured to cause linear adjustment of the distance between the forehead pad support and the display frame.

12. The wearable display device of claim 11, wherein the adjustment mechanism comprises:
a first rack and pinion coupling the forehead pad frame to the extension member;
a second rack and pinion coupling the forehead pad frame to the extension member; and
a timing mechanism extending between the first rack and pinion and the second rack and pinion.

13. The wearable display device of claim 11, wherein the adjustment mechanism comprises:
a lead screw coupling the forehead pad frame to the extension member;
a shaft;
a gearbox coupling the shaft and the lead screw; and
a dial coupled to the shaft and configured to extend and retract the lead screw.

14. The wearable display device of claim 11, wherein the adjustment mechanism comprises a locking mechanism configured to hold the extension member at the distance.

15. The wearable display device of claim 11, wherein the forehead pad frame is removably coupled to the display frame.

16. A wearable display device, comprising:
a display frame;
an optical module coupled to the display frame; and
an adjustable forehead pad system, comprising:
a forehead pad frame coupled to the display frame;
a bistable link extension member; and
a forehead pad support;
wherein the adjustable forehead pad system is configured to move between a retracted position and an extended position.

17. The wearable display device of claim 16, wherein:
the forehead pad frame comprises a frame coupler;
the forehead pad support comprises a forehead pad coupler; and
the bistable link extension member comprises a link coupling the frame coupler to the forehead pad coupler.

18. The wearable display device of claim 17, wherein the bistable link is rotatably coupled to the frame coupler and the forehead pad coupler.

19. The wearable display device of claim 16, wherein the adjustable forehead pad system is configured to move from the retracted position to the extended position via user manipulation.

20. The wearable display of claim 16, wherein the adjustable forehead pad system further comprises an adjustment mechanism configured to cause the adjustable forehead pad system to move between the retracted position and the extended position.
